(19) United States
(12) Patent Application Publication
(10) Pub. No.: US 2026/0304560 A1
(43) Pub. Date: Oct. 1, 2026

(54) DEVICE AND A METHOD FOR DETERMINING A CATEGORY OF A QUALITY OF A WIRELESS COMMUNICATIONS CHANNEL

(71) Applicant: Robert Bosch GmbH, Stuttgart (DE)

(72) Inventors: Maximilian Stark, Hamburg (DE); Marie-Theres Suer, Braunschweig (DE); Sebastian Lindner, Hamburg (DE)

(21) Appl. No.: 19/536,550

(22) Filed: Feb. 11, 2026

(30) Foreign Application Priority Data
Mar. 5, 2025 (DE) 10 2025 108 363.0

(51) Int. Cl. H04W 84/12; H04W 48/20; H04W 88/08

(52) U.S. Cl. CPC H04W 84/12; H04W 48/20; H04W 88/08

(57) ABSTRACT

A device and a method for determining a category of a quality of a wireless communications channel. The method includes measuring a time course of an activity on the wireless communications channel, in particular of the power received on the wireless communications channel, and mapping the time course of the activity with a model to the category, wherein the model is configured for mapping the time course of the activity to the category.

### CROSS REFERENCE

The present application claims the benefit under 35 U.S.C. § 119 of Germany Patent Application No. DE 10 2025 108 363.0 filed on Mar. 5, 2025, which is expressly incorporated herein by reference in its entirety.

### FIELD

The present disclosure concerns a device and a method for determining a category of a quality of a wireless communications channel.

### BACKGROUND INFORMATION

Approaches for improving system performance of a wireless communications system include packet prioritization, coordination among systems, and channel switching.

### SUMMARY

A method according to the present disclosure enables enhancing a channel switching mechanism through improved channel classification. The channel classification classifies the quality into categories.

According to an example embodiment, the method for determining a category of the quality of a wireless communications channel comprises measuring a time course of an activity on the wireless communications channel, in particular of the power received on the wireless communications channel, and mapping the time course of the activity with a model to the category, wherein the model is configured for mapping the time course of the activity to the category. The model predicts the category. Considering the time course improves the accuracy of the prediction of the model.

The wireless communications channel is preferably part of or associated with a wireless communications network. The wireless communications network may be a cellular network, e.g., according to 3GPP specifications, or a wireless Local Area Network, e.g., according to IEEE 802.11 specifications.

According to an example embodiment, tor training the model, the method may comprise providing a training activity and a target for the category, mapping the training activity with the model to the category for the training activity, and training the model depending on difference between the target for the category and the category for the training activity.

Providing the training activity may comprise measuring the training activity during a communication or a simulation of a communication on the wireless communications channel having the quality according to the target for the category.

For a wireless communications network that is configured for joining a station to the wireless communications network, providing the training activity may comprise providing a time at that the station joins the wireless communications network, wherein the time lies within a duration of measuring the training activity, and simulating that the station joins the wireless communication network at the time.

Providing the time may comprise providing a distribution, in particular an exponential distribution, of times during measuring the training and sampling the time from the distribution.

For a wireless communications network that comprises an access point, wherein the access point is configured for associating a station with the communications network, providing the training activity may comprise providing a duration of a time period during that the access point associates the station with the wireless communications network, wherein the duration lies during measuring the training activity, and simulating that the access point associates the station with the wireless communications network for the duration, or wherein providing the training activity comprises providing an amount of traffic communicated throughout an association in which the access point associates the station with the wireless communications network, and simulating that the access point associates the station with the wireless communications network with the amount of traffic.

Providing the duration may comprise providing a distribution, in particular an exponential distribution, of durations that lie within a duration of measuring the training activity, and sampling the duration from the distribution.

Providing the amount may comprise providing a distribution, in particular a normal distribution, of amounts, and sampling the amount from the distribution.

For a wireless communications network that comprises a first access point and a second access point, providing the training activity may comprise measuring the training activity with the first access point while the first access point and the second access point use separate wireless communications channels, or while simulating that the first access point and the second access point use separate wireless communications channels.

For a wireless communications network that comprises a first access point and a second access point, providing the training activity may comprise measuring the training activity with the first access point while the first access point and the second access point use the same wireless communications channel, or while simulating that the first access point and the second access point use the same wireless communications channel.

According to an example embodiment, the method may comprise training the model with the training activity measured while the first access point and the second access point use separate wireless communications channels or while simulating that the first access point and the second access point use separate wireless communications channels, and training the model with the training activity measured while the first access point and the second access point use the same wireless communications channel or while simulating that the first access point and the second access point use the same wireless communications channel. This means, the model is trained based on training activity without interference by the second communications channel and training activity comprising interference cause by the second communications channel.

A device for determining a category of a quality of a wireless communications channel, is configured for executing a method of the present disclosure.

A computer program for determining a category of a quality of a wireless communications channel comprises computer-readable instructions that, when executed by a computer, cause the computer to execute a method of the present disclosure.

A non-transitory storage medium for determining a category of a quality of a wireless communications channel comprises computer-readable instructions that, when executed by a computer, cause the computer to execute a method of the present disclosure.

Further examples are derived from the following description and the figures.

### BRIEF DESCRIPTION OF THE DRAWINGS

FIG. 1 schematically depicts a wireless communications network, according to an example embodiment.

FIG. 2 depicts an exemplary time course of a power received on a wireless communications channel of the wireless communications network.

FIG. 3 depicts a flow chart comprising steps of a method for determining a category of a quality of a wireless communications channel, according to an example embodiment.

### DETAILED DESCRIPTION OF EXAMPLE EMBODIMENTS

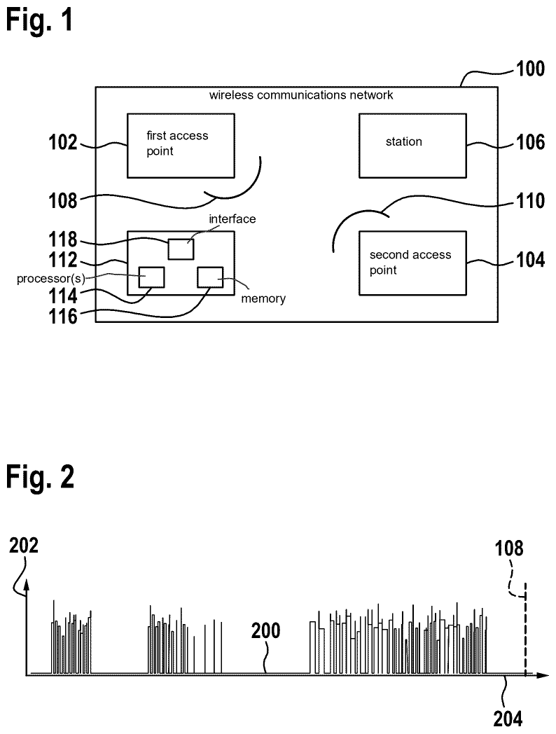

FIG. 1 depicts a wireless communications network 100. The wireless communications network 100 comprises a first access point 102. The wireless communications network 100 comprises a second access point 104.

The wireless communications network 100 may at least temporarily comprise only the first access point 102 or more than the first access point 102 and the second access point 104.

The first access point 102 may be configured to associating a station 106 with the wireless communications network 100.

The first access point 102 is configured to provide a first wireless communications channel 108.

The second access point 104 is configured to provide a second wireless communications channel 110.

The wireless communications network 100 comprises a device 112 for determining a category of a quality of a wireless communications channel.

According to an example, the device 112 is configured for determining the category of the quality of the first wireless communications channel 108.

The device 112 comprises at least one processor 114 and at least one memory 116.

The device 112 may comprise an interface 118 for measuring a time course of an activity on the first wireless communications channel 108.

The device 112 may comprise the interface 118 for receiving the measured time course of the activity on the first wireless communications channel 108.

The first access point 102 may comprise the device 112.

According to an example, the time course of the activity is a power received on the first wireless communications channel 108.

FIG. 2 depicts an exemplary time course 200 of the power 202 received over time 204 on the first wireless communications channel 108.

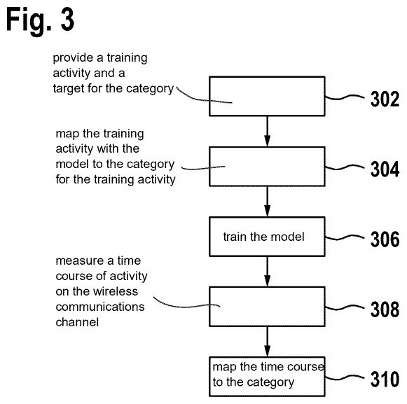

FIG. 3 depicts a flow chart comprising steps of a method for determining a category of a quality of a wireless communications channel.

The device 112 is configured for executing the method.

The method is based on a model that is configured for mapping the time course of the activity to the category.

The model for example comprises neural network, in particular a deep neural network. The architecture of the neural network is for example a recurrent neural Network (RNN) architecture or a Long Short Term Memory (LSTM) architecture.

The method comprises a step 302.

The step 302 comprises providing a training activity and a target for the category.

The step 302 may comprise measuring the training activity during a communication or a simulation of a communication on the wireless communications channel 108 having the quality according to the target for the category.

The step 302 may comprise providing a time at that the station 106 joins the wireless communications network 100, and simulating that the station 106 joins the wireless communication network 100 at the time. The time lies within a duration of measuring the training activity. The time may be provided from a given distribution of times that lie within the duration of measuring. The time may be sampled from the distribution of times. The distribution of times is for example an exponential distribution.

The step 302 may comprise providing a duration of a time period during that the access point 102 associates the station 106 with the wireless communications network 100, and simulating that the access point 102 associates the station 106 with the wireless communications network 100 for the duration. The duration lies during measuring the training activity.

The duration may be provided from a given distribution of durations that lie within a duration of measuring the training activity. The duration may be sampled from the distribution of durations. The distribution of durations is for example an exponential distribution.

The step 302 may comprise providing an amount of traffic communicated throughout an association in which the access point 102 associates the station 106 with the wireless communications network 100, and simulating that the access point 102 associates the station 106 with the wireless communications network 100 with the amount of traffic.

The amount may be provided from a distribution of amounts. The amount may be sampled from the distribution of amounts. The distribution of amounts is for example a normal distribution.

The step 302 may comprise measuring the training activity with the first access point 102 while the first access point 102 and the second access point 104 use separate wireless communications channels, i.e. the first access point 102 uses the first wireless communications channel 108 and the second access point 104 uses the second wireless communications channel 110.

The step 302 may comprise measuring the training activity while simulating that the first access point 102 and the second access point 104 use separate wireless communications channels, i.e. the first access point 102 uses the first wireless communications channel 108 and the second access point 104 uses the second wireless communications channel 110.

The step 302 may comprise measuring the training activity with the first access point 102 while the first access point 102 and the second access point 104 use the same wireless communications channel, i.e. the first wireless communications channel 108.

The step 302 may comprise measuring the training activity with the first access point 102 while simulating that the first access point 102 and the second access point 104 use the same wireless communications channel, i.e. the first wireless communications channel 108.

The method comprises a step 304.

The step 304 comprises mapping the training activity with the model to the category for the training activity.

the method comprises a step 306.

The step 306 comprises training the model depending on difference between the target for the category and the category for the training activity.

The step 306 comprises for example training the model with the categories determined for the measured training activities.

The training activities for the training may comprise a training activity measured while the first access point 102 and the second access point 104 use separate wireless communications channels.

The training activities for the training may comprise a training activity measured while simulating that the first access point 102 and the second access point 104 use separate wireless communications channels.

The training activities for the training may comprise a training activity measured while the first access point 102 and the second access point 104 use the same wireless communications channel.

The training activities for the training may comprise a training activity measured while simulating that the first access point 102 and the second access point 104 use the same wireless communications channel.

The method may end after the training.

For inference, the method may comprise a step 308. A method for inference may start based on the trained model with the step 308.

The step 308 comprises measuring a time course of an activity on the wireless communications channel 108.

The step 308 for example comprises measuring the course of the power 202 received on the first wireless communications channel 108.

Afterwards, a step 310 is executed.

The step 310 comprises mapping the time course of the activity with the model to the category.

The model may be trained to map channels with similar quality to the same category. For example, the model is trained to map the first wireless communications channel 108, the second wireless communications channel 110 and a third wireless communications channel to one of five classes, that represent different categories of quality. For example class 1 denotes the category for a wireless communications channel of the best quality, followed by classes 2, 3, 4, and 5 denoting further categories for the wireless communication channel in order of descending quality.

An exemplary channel quality list (CQL) comprising the mapping of classes to channel for the three wireless communications channels is:

| | Class 1 | Class 2 | Class 3 | Class 4 | Class 5 |
|---|---|---|---|---|---|
| Channel 1 | x | | | | |
| Channel 2 | | | | x | |
| Channel 3 | | x | | | |

This means, the model maps a time course of an activity on the Channel 1 to the category Class 1. This means, the model maps a time course of an activity on the Channel 2 to the category Class 4. This means, the model maps a time course of an activity on the Channel 3 to the category Class 2.

The CQL using the mapping of the time course of an activity to a category mitigates oscillatory behavior that could otherwise happen due to a switching of channels based on a CQL changing based on only a single point in time instead of the time course of the activity.

What is claimed is:

1. A method for determining a category of a quality of a wireless communications channel, the method comprising the following steps:
measuring a time course of an activity on the wireless communications channel, the activity including power received on the wireless communications channel; and
mapping the time course of the activity with a model to the category, wherein the model is configured for mapping the time course of the activity to the category.

2. The method according to claim 1, further comprising:
providing a training activity and a target for the category;
mapping the training activity with the model to the category for the training activity; and
training the model depending on a difference between the target for the category and the category for the training activity.

3. The method according to claim 2, wherein the providing of the training activity includes:
measuring the training activity, during a communication or a simulation of a communication, on the wireless communications channel having the quality according to the target for the category.

4. The method according to claim 3, wherein a wireless communications network is configured for joining a station to the wireless communications network, wherein the providing of the training activity includes:
providing a time for the station to join the wireless communications network, wherein the time lies within a duration of measuring the training activity, and
simulating that the station joins the wireless communications network at the time.

5. The method according to claim 4, wherein the providing of the time includes:
providing an exponential distribution of times during the measuring of the training activity; and
sampling the time from the distribution.

6. The method according to claim 3, wherein a wireless communications network includes an access point, wherein the access point is configured for associating a station with the wireless communications network, and wherein the providing of the training activity includes:
(i) providing a duration of a time period during which the access point associates the station with the wireless communications network, wherein the duration lies during measuring the training activity, and simulating that the access point associates the station with the wireless communications network for the duration, or
(ii) providing an amount of traffic communicated throughout an association in which the access point associates the station with the wireless communications network, and simulating that the access point associates the station with the wireless communications network with the amount of traffic.

7. The method according to claim 6, wherein the providing of the duration includes:
providing an exponential distribution of durations that lie within a duration of measuring the training activity; and
sampling the duration from the distribution.

8. The method according to claim 6, wherein the providing of the amount includes:
providing a normal distribution of amounts; and
sampling the amount from the distribution.

9. The method according to claim 3, wherein a wireless communications network includes a first access point and a second access point, wherein the providing of the training activity includes:
measuring the training activity with the first access point (i) while the first access point and the second access point use separate wireless communications channels, or (ii) while simulating that the first access point and the second access point use separate wireless communications channels.

10. The method according to claim 9, wherein a wireless communications network includes a first access point and a second access point, and wherein the providing of the training activity includes:
measuring the training activity with the first access point: (i) while the first access point and the second access point use the same wireless communications channel, or (ii) while simulating that the first access point and the second access point use the same wireless communications channel.

11. The method according to claim 10, further comprising:
training the model with the training activity measured: (i) while the first access point and the second access point use separate wireless communications channels, or (ii) while simulating that the first access point and the second access point use separate wireless communications channels; and
training the model with the training activity measured: (i) while the first access point and the second access point use the same wireless communications channel, or (ii) while simulating that the first access point and the second access point use the same wireless communications channel.

12. A device for determining a category of a quality of a wireless communications channel, the device configured to:
measure a time course of an activity on the wireless communications channel, including power received on the wireless communications channel; and
map the time course of the activity with a model to the category, wherein the model is configured for mapping the time course of the activity to the category.

13. A non-transitory storage medium on which are stored computer-readable instructions for determining a category of a quality of a wireless communications channel, the instructions, when executed by a computer, causing the computer to perform the following steps:
measuring a time course of an activity on the wireless communications channel, including power received on the wireless communications channel; and
mapping the time course of the activity with a model to the category, wherein the model is configured for mapping the time course of the activity to the category.
